(19) United States
(12) Patent Application Publication
(10) Pub. No.: US 2005/0071369 A1
(43) Pub. Date: Mar. 31, 2005

(54) Object tailoring

(76) Inventors: Peter Lang, Bad Schonborn (DE); Markus Ehrnsperger, Walldorf (DE); Steffen Springborn, Edingen-Neckarhausen (DE); Dieter Krisch, Karlsruhe (DE); Gertrude Guth, Heidelberg (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/674,327

(22) Filed: Sep. 29, 2003

(51) Int. Cl. G06F 17/00

(52) U.S. Cl. 707/103 R

(57) ABSTRACT

Systems and techniques for tailoring the storage of information. In one implementation, a computer program product is operable to cause data processing apparatus to create a framework of elements to present a user with a presentation of options for tailoring an object, receive user input for tailoring the object in response to the presentation of options, define the tailored object to include the first field and the second field, associate an identifier of the first participant with the first field to indicate that the first participant is to be excluded from a first activity performed with the first field, and associate an identifier of the second participant with the second field to indicate that the second participant is to be excluded from a second activity performed with the second field. The received user input can identify a first field to be included in the tailored object, a second field to be included in the tailored object, a first participant, and a second participant. The computer program product can be tangibly embodied in an information carrier.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This disclosure relates to data processing and tailoring the storage of information for use in data processing.

Data objects are elements for information storage in object-oriented systems. Data objects can describe the attributes of an item using a series of data fields that, for example, can correspond to described characteristics and references to other objects that include germane descriptive information. Typically, a programmer will predefine a collection of standard object classes that are hardcoded into a set of machine-readable instructions for performing operations. Object classes are blueprints for describing individual objects using a defined set of class attributes (or properties). Instantiated objects that are members of such standard object classes can be applied in a variety of different data processing activities by users such as customers who are largely unaware of the structure of the standard classes.

### SUMMARY

The present invention provides methods and apparatus, including computer program products, for tailoring data objects and the storage of information using tailored data objects. The methods and apparatus of the present invention can be used by an untrained user such as a client customer to tailor classes of data objects. The methods and apparatus can provide a framework of various elements, such as graphic user interfaces screens, that lead an untrained user through the tailoring process without ever requiring that the untrained user hard code a data object class.

In general, in one aspect, the invention features a computer program product that is operable to cause data processing apparatus to create a framework of elements to present a user with a presentation of options for tailoring an object, receive user input for tailoring the object in response to the presentation of options, define the tailored object to include the first field and the second field, associate an identifier of the first participant with the first field to indicate that the first participant is to be excluded from a first activity performed with the first field, and associate an identifier of the second participant with the second field to indicate that the second participant is to be excluded from a second activity performed with the second field. The received user input can identify a first field to be included in the tailored object, a second field to be included in the tailored object, a first participant, and a second participant. The computer program product can be tangibly embodied in an information carrier.

Implementations of this and other aspects can include one or more of the following features. The instructions can also cause the processor to create a framework of elements to exclude the first participant from the first activity performed with the first field or to receive user input identifying a roll that the first participant plays in an operation. An identifier of the roll can be associated with the first field.

User input identifying a fieldgroup that includes the field can be received. The instructions can also cause the processor to receive first user input identifying the first field and the second field from a first user and to receive second user input identifying the first participant and the second participant from a second user. The received user input can identify the first activity from which the first user is excluded from performing with the first field, and the instructions cause the processor to create a framework of elements to receive user input identifying an authorization level identifying the first activity from which the user is precluded. For example, user input selecting the authorization level from a group of at least four authorization levels can be received.

The instructions can also cause the processor to create a framework of elements to identify a trigger and, based upon the identification of the trigger, end the association of the identifier of the first participant with the first field to indicate that the first participant is no longer excluded from the first activity.

The instructions can also cause the processor to create a framework of elements to receive user input identifying a noperation performed with the tailored object and associate an identifier of the operation, the identifier of the first participant, and the first field to indicate that the first participant is to be excluded from the first activity performed with the first field in the operation. User input identifying a collaboration of at least two parties can be received.

The instructions can also cause the processor to create a framework of elements to instantiate the defined tailored object. The first activity can include the display of the first field and the second activity can include the display of the second field. The instructions can also cause the processor to create a graphical user interface to lead an untrained user through the tailoring. For example, the graphical user interface can be created on an web browser.

In another aspect, a system includes a data storage device including tailored data objects and a data processing device in data communication with the information storage device. The tailored data objects have user-defined data fields. The data processing device is configured to perform data processing activities in accordance with a set of machine-readable instructions. The activities can include identifying a trigger and changing a status of a field in a first tailored object based on the identification of the trigger. The status of the field can identify an activity performed with the field and a participant who is excluded from performing the activity with the field.

Implementations of this and other aspects can include one or more of the following features. Changing the status of the field can include ending a preclusion of the identified participant from performance of the identified activity or releasing a predefined field for display for all participants. The system can include operational instructions for the creation of a product. The first tailored data object can include structured elements hardcoded into the first tailored data object and hence not definable by a user and tailored elements including the user-defined data fields. The standard elements can be found in every member of a group of data objects that includes the first tailored data object.

The data processing device activities can include receiving user input identifying an operation performed with the tailored object and associating an identifier of the operation with the status to indicate that the status is relevant to the operation. The operation can include the activity performed with the field. User input identifying a collaboration of at least two parties can also be received.

In other aspect, a memory for storing data for access during performance of a set of machine-readable instructions for performing operations on a data processing system includes a data structure. The data structure can include a data structure identifier, a collection of one or more hardcoded elements hardcoded into the data structure, a collection of one or more tailored elements to fit a specific data processing activity of a user.

Implementations of this and other aspects can include one or more of the following features. The data structure can also include user identification information identifying a user and activity identification information identifying an activity from which the user is excluded. The collection of tailored elements can include a field to fit the specific data processing activity. The activity identification information can identify the activity according to the field in the collection of tailored elements. The user identification information can include an authorization level, for example, one of four or more authorization levels.

The memory can include an association identifying that the data structure is associated with a particular operation. The data structure can be an XML file. The memory can include a communications application for exchange of the data structure with a remote system. For example, the communications application can be a web service.

The invention can be implemented to realize one or more of the following advantages. A user can define tailored object classes without programming expertise. The class definition can identify users who are excluded from performing activities with the tailored object. These exclusions can be defined at the level of the tailored object, at the level of fieldgroups within the tailored object, or at the level of individual fields within the tailored object. Such precision control of the exclusion of users from activities can increase the flexibility of operations performed with the tailored objects.

An object class in a system can be re-defined, even after the system has been installed at a customer site. Even a customer who lacks programming expertise can re-define the class by providing inputs through a graphical user interface.

A set of machine-readable instructions can be executed by a data processing device to performe operations that re-define an object class, for example, change the exclusion of participants from activities. The redefinition of a tailored object class can also identify triggers that activate the exclusion of participants from activities. Such triggers can be used to implement workflow procedures using tailored objects. For example, fields that are initially hidden can be made viewable when a trigger indicates that such a change is necessary.

Objects can be tailored differently for different participants in an operation. For example, a marketing department may desire additional fields in a tailored object that are not desired by an engineering department. Tailored objects for the marketing department can include tailored elements relevant only to marketing and tailored objects for the engineering department can include tailored elements relevant only to engineering. Both marketing and engineering tailored elements can include standard elements that are relevant to both departments and facilitate data exchange between the two departments.

The exclusion of users from activities can be accomplished through the definition of authorization levels that identify groups of activities from which a participant is excluded. A number of different authorization levels, for example, four, can be used to identify precluded activities with precision.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 shows a data processing system where objects can be tailored and applied.

FIG. 2 shows a process in which the storage of information in a data object can be tailored.

FIG. 3 shows an example of an object data store.

FIGS. 4 and 5 show examples of instantiated tailored data objects.

FIG. 6 shows an example of tailored elements in a tailored data object.

FIG. 7 shows a process in which a tailored object class is associated with an operation.

FIG. 8 shows a screenshot of a user interface for interacting with a user to receive a user selection of a tailored object class.

FIG. 9 shows an example of tables that associate tailored object classes with operation operations.

FIG. 10 shows an example of an instantiated tailored data object.

FIG. 11 shows another implementation of tailored elements in a tailored data object.

FIG. 12 shows examples of different authorization levels for data processing activities.

FIG. 13 shows a process in which authorizations can be used to exclude users from data processing activities involving tailored objects and tailored object classes.

FIG. 14 shows a screenshot of a user interface for interacting with a user to receive user input indicating that a participant is precluded from a data processing activity.

FIG. 15 shows an example of tables that associate status profiles with identifications of tailored object classes and various operations.

FIG. 16 shows a process in which changes in a status profile are used to perform data processing activities involving tailored objects and tailored object classes.

FIGS. 17 and 18 illustrate one example of how a change in the status profile associated with a tailored object can impact activities performed with the tailored object.

FIG. 19 shows another data processing system where objects can be tailored and applied.

Like reference symbols in the various drawings indicate like elements.

### DETAILED DESCRIPTION

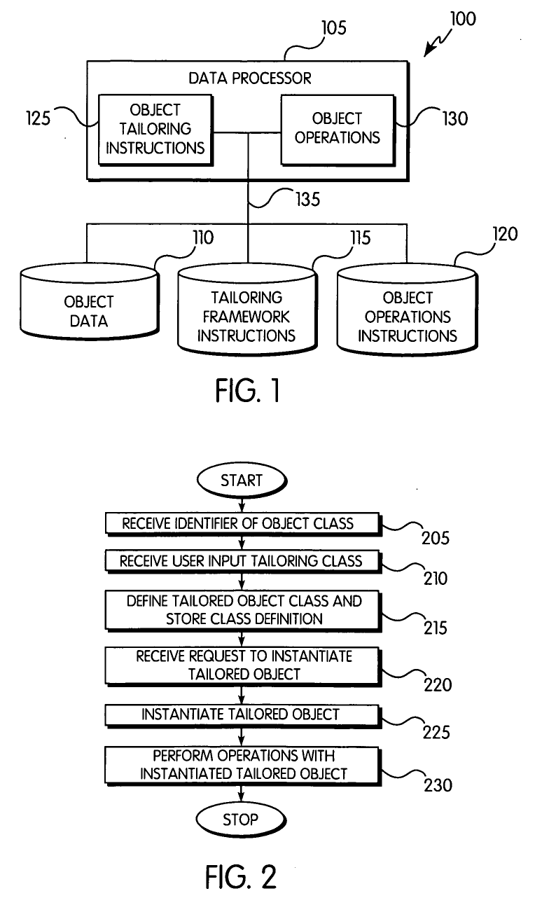

As shown in FIG. 1, a data processing system 100 in accordance with the invention includes a data processor 105, an object data store 110, a tailoring framework instruction store 115, and an object operations instruction store 120. Data processor 105 can be a data processing device and/or software that performs processing activities such as an object tailoring operations 125 and an object operations 130 in accordance with the logic of a set of machine-readable instructions. Stores 110, 115, 120 are repositories of machine-readable information such as instructions and data for processing activities such as object tailoring system 125 and object operations 130. Stores 110, 115, 120 can be located at one or more memory devices or servers. Data processor 105 and stores 110, 115, 120 are placed in data communication by a data link 135. Data link 135 allows instructions and data regarding processing activities to be exchanged between data processor 105 and stores 110, 115, 120. For example, data link 135 can be a bus or a data communication link in a network.

Object tailoring operations 125 provide a framework for a user to tailor the storage of information by defining an object class. Objects of the user-defined object class (hereinafter tailored objects) can be structured in a variety of ways to fit the specific data processing activities of the user. For example, a customer can specify field types, fieldgroup assignments, and references in the tailored objects. User-specified elements can have semantic structures identified by the user, and default elements can be identified and have default values assigned by the user.

Object operations 130 allows the same or different users to apply tailored objects in data processing activities. The application of tailored objected in these activities can include instantiation of the tailored objects as well as read, write, or other operations that populate or otherwise modify the content of an instantiated tailored object.

FIG. 2 shows a process 200 in which the storage of information in a data object can be tailored. Process 200 can be performed by data processor 105 in data processing system 100 or by one or more other data processing systems that is executing machine-readable instructions for performing operations such as object tailoring operations 125 and object operations 130, as shown in FIG. 1.

The system performing process 200 can receive an identifier for the class of a tailored object (step 205). The identifier can be a name, a description, or other information that can be used to identify the class of a tailored object. The identifier can be received directly from a user or it can be assigned by the system without user input. The identifier or its equivalent can be included as metadata in tailored objects of the identified class.

The system can also receive user input for tailoring the identified class (step 210). The received user input can provide information for structuring tailored objects of the identified class to fit the specific data processing activities of the user. The received user input can include user specification of field types in a tailored object, fieldgroup assignments in a tailored object, and references in a tailored object. For example, the user specification of references can include links or pointers to other data objects. The received user input can identify the semantic structure of elements in a tailored object. The received user input can identify default elements and assign default values to a tailored object. The received user input need not provide information for structuring every element in a tailored object of the identified class. For example, the user input can provide information for structuring specific fields within a tailored object, whereas other fields are assigned default structures or predefined structures hardcoded into the tailored object.

The user input can be received directly from a user over one or more input devices communicatively coupled to the system. The user input can be received over a user interface that includes interaction elements resulting from the execution of machine-readable instructions. The interaction elements can guide a user who lacks expertise through the tailoring the identified class. For example, the interaction elements can present the user with a list or other presentation of available options for tailoring the identified class. The received user input can include a selection from amongst the presented options.

The system can define an object class based on the received tailoring input and store the class definition (step 215). Defining the object class can include defining a class declaration with the received class identifier and various aspects of the class and defining a class body that structures and organizes the fields and references of the object class. The class definition can be stored at a data storage device in machine-readable format.

The system can also receive a request to instantiate a tailored object of the defined object class (step 220) and respond to the request by instantiating the object (step 225). The instantiation request can be received directly from a user or it can be generated automatically without direct user input, for example, during the performance of data processing activities.

The system can also perform operations with the instantiated tailored object (step 230). The operations can include read, write, or other operations that populate or otherwise modify the content of the instantiated tailored object. Since the object class of the instantiated tailored object has been structured to fit the specific data processing activities of the user, the performance of such activities can be facilitated by the use of the instantiated tailored object.

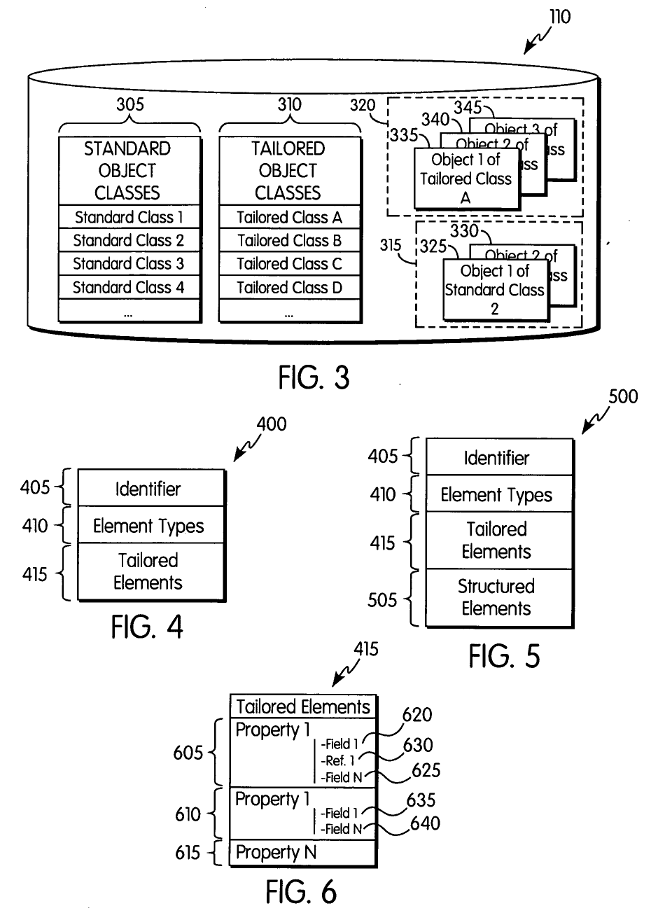

FIG. 3 shows an example of an object data store 110. Object data store 110 can be located at one or more memory devices or servers.

Object data store 110 includes a collection of standard object class definitions 305, a collection of one or more tailored object class definitions 310, a series of instantiated standard objects 315, and a series of instantiated tailored objects 320. Collection of standard object class definitions 305 can include predefined definitions of standard object classes. The definitions can be hardcoded into a set of machine-readable instructions. For example, the definitions can be defined in the source code of a set of machine-readable instructions, or the definitions can be defined by a producer of the instructions and not readily changed by users of the instructions. Standard object class definition collection 305 can be a table of standard object class definitions.

Collection of tailored object class definitions 310 can include definitions of tailored object classes that have been structured based on user input. The user input can be received by a data processor over a tailoring framework for receiving user input and defining an object class based on the received user input. The tailoring framework can be associated with a set of machine-readable operations instructions describing data processing operations that are performed with objects tailored by using the tailoring framework. For example, the tailoring framework can be associated with the operations instructions by packaging the framework with the operations instructions, by including the framework in the operations instructions, or by explicitly identifying that the framework is to be used with the operations instructions. Tailored object class definition collection 310 can be a table of tailored object class definitions.

Instantiated standard object series 315 includes a series of instantiated standard objects that are members of the standard object classes defined in standard object class definition collection 305. For example, instantiated standard object series 315 can include instantiations 320, 325 of a standard object class 2 defined in standard object class definition collection 305.

Instantiated tailored object series 320 includes a series of instantiated tailored objects that are members of the tailored object classes defined in tailored object class definition collection 310. For example, instantiated tailored object series 320 can include instantiations 330, 335, 340 of a tailored object class A defined in tailored object class definition collection 310.

FIGS. 4 and 5 show examples of instantiated tailored data objects 400 and 500. Tailored data objects 400 and 500 each includes an identifier 405, a data type declaration 410, and tailored elements 415. Tailored data object 500 also includes structured elements 505. Identifier 405 can uniquely identify instantiated object 400. Identifier 405 can also identify the class and other aspects of instantiated object 400. Element type declaration 410 identifies the types of elements found in instantiated object 400. Identified element types can include standard types (such as strings, characters, arrays, reals, integers, Booleans, and so forth) and user defined types. Tailored elements 415 are one or more fields and references that have been structured to fit the specific data processing activities of the user. Structured elements 505 are one or more fields and references that have been assigned predefined structures hardcoded into data object 500. Structured elements 505 can be standard elements of a group of data objects that includes tailored data object 500.

FIG. 6 shows an example of tailored elements 415. Tailored elements 415 include fieldgroups 605, 610, 615. Fieldgroups 605, 610, 615 each include one or more elements. For example, fieldgroup 605 includes fields 620, 625 and a reference 630 and fieldgroup 610 includes fields 635, 640.

Tailored elements 415 can be structured to fit the specific data processing activities of a user in a variety of ways. For example, a user can add or delete fields and references from each fieldgroup 605, 610, 615. The user can reassign fields or references between fieldgroups 605, 610, 615. The user can declare the element type of the data in fields 620, 625, 635, 640 and fieldgroup 610.

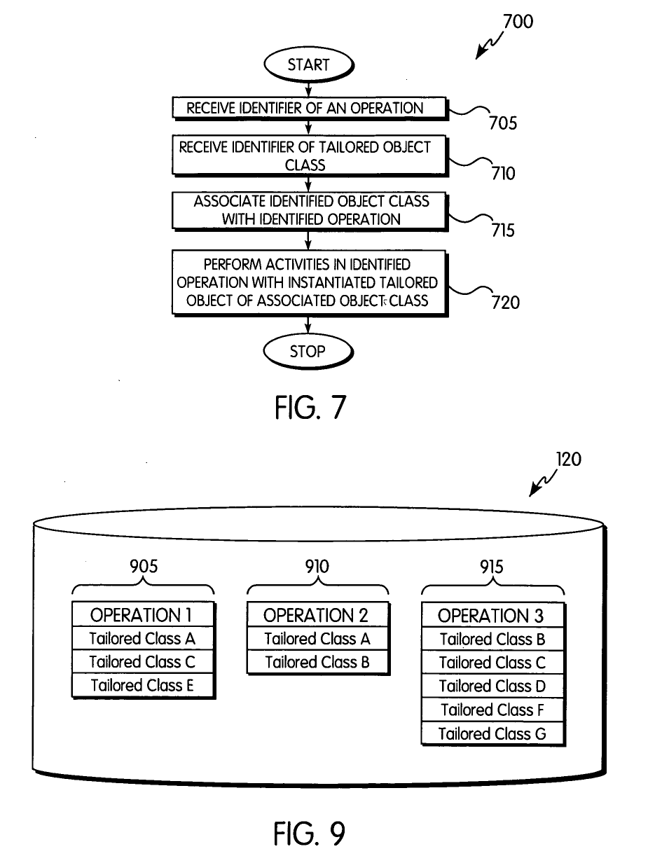

FIG. 7 shows a process 700 in which a tailored object class can be associated with an operation. An operation is a set of associated data processing activities that can apply a tailored object. The activities in an operation can be associated by a common purpose, a common function, or other common characteristic. For example, the activities in an operation can be devoted to the performance of a particular project or to a particular collaboration. A collaboration is a set of data processing activities performed by two or more parties. The data processing activities in a collaboration can be functionally directed to achieving a common end between the parties. The relationships and activities of the parties can be defined within a collaboration framework. A collaboration framework can include two or more companies and their relationships, the individuals and groups and their roles and authorizations, as well as the shared processes. The application of tailored objected in a collaboration framework can include instantiation of the tailored objects as well as read, write, or other activities that populate or otherwise modify the content of an instantiated tailored object. A collaboration framework can define how and if tailored objects can be applied by a party to a collaboration. An example collaboration framework is the mySAP PLM cProject Suite™ available from SAP AGC Walldorf, Germany.

Process 700 can be performed by data processor 105 in data processing system 100, as shown in FIG. 1, or by one or more other data processing systems that is executing machine-readable instructions for performing operations.

The system performing process 700 can receive an operation identifier (step 705) and an identifier of a tailored object class (step 710). The operation identifier and the tailored object class identifier can be received from a user, for example, over an input device such as a keyboard or mouse. The identifiers can be selections of a particular operation and a particular tailored object class from a list of potential operations and a list of potential tailored object classes. The identified operation can be a project or a collaboration.

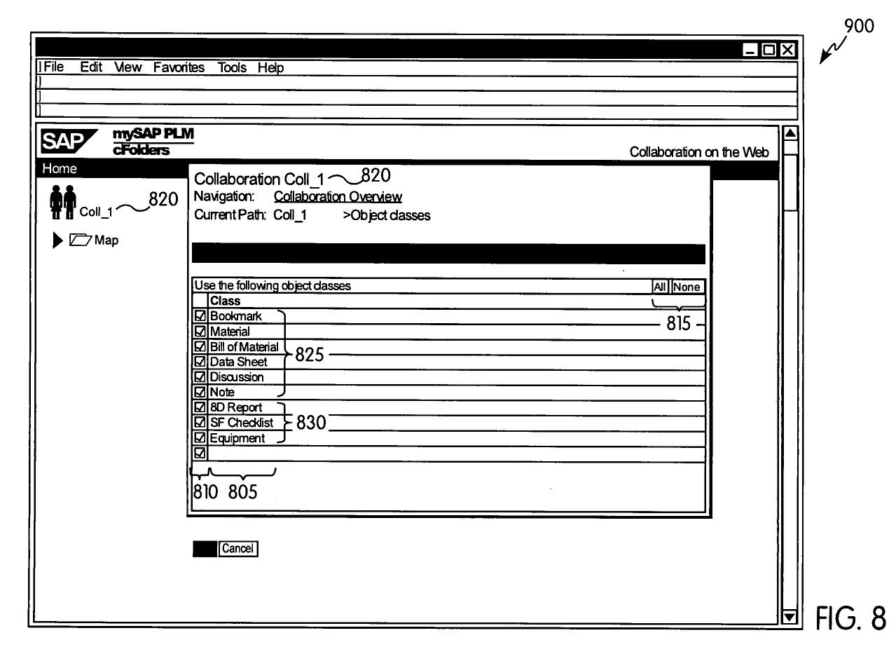

FIG. 8 shows an example screenshot 800 of a list 805 of potential object classes and the receipt of user selection of a tailored object class identifiers by way of a user-interface checklist 810 and all-or-none buttons 815 for an identified process 820. List 805 include both standard object classes 825 and tailored object classes 830. Screenshot 800 can be the screen of a web browser or other application for locating and displaying remote content such as graphic content, text content, and multimedia content.

As shown in FIG. 7, the system can associate the identified tailored object class with the identified operation (step 715). Associating the identified tailored object class with the identified operation includes generating a machine-readable indication that the identified tailored object class is used in the identified operation. For example, the tailored object class can be associated with the operation by metadata in a tailored object class definition or by storing a collection of tailored objects associated with the operation. FIG. 9 shows an example of how a set of object operations instructions 120 can include tables 905, 910, 915 that identify tailored object classes that can be applied in various operations.

As shown in FIG. 7, the system can also perform activities in the identified operation with an instantiated tailored object of the associated object class (step 720). The activities can include read, write, or other activities that populate or otherwise modify the content of the instantiated tailored object.

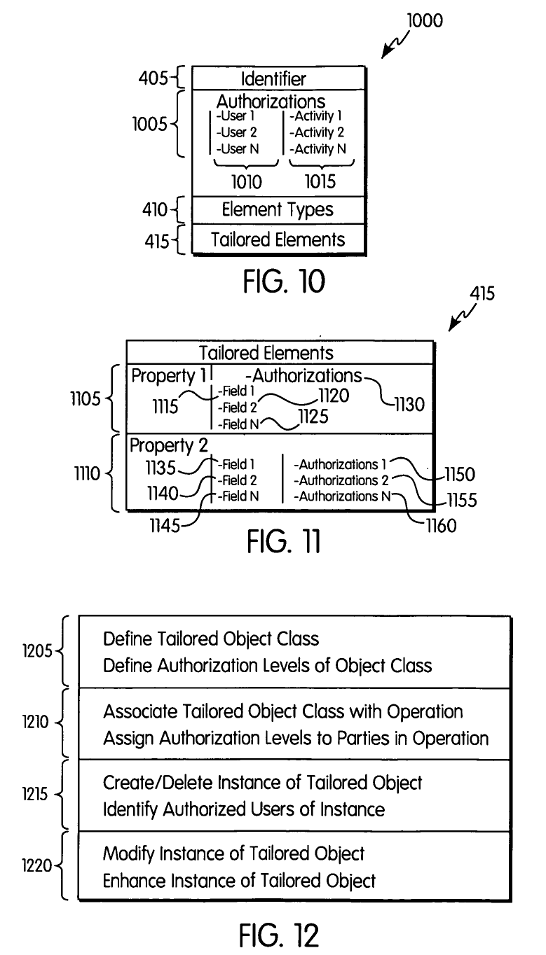

FIG. 10 shows an example of an instantiated tailored data object 1000. Tailored data object 1000 includes identifier 405, data type declaration 410, tailored elements 415, and one or more authorizations 1005. Authorizations 1005 include user identifications 1010 and activity identifications 1015. User identifications 1010 identify users by name, by characteristic, or by roll in an enterprise or project. Each of user identifications 1010 can be associated with one or more activity identifications 1015 which identify activities from which the user is excluded.

FIG. 11 shows another implementation of tailored elements 415. Tailored elements 415 include fieldgroups 1105, 1110. Fieldgroup 1105 includes fields 1115, 1120, 1125 and a fieldgroup authorization 1130. Fieldgroup 1110 includes fields 1135, 1140, 1145 and field authorizations 1150, 1155, 1160. Fieldgroup authorization 1130 can be used to exclude a user from performing data processing activities that involve fieldgroup 1110. Each of field authorizations 1150, 1155, 1160 can be used to exclude a user from performing a data processing activity that involve the respective of fields 1135, 1140, 1145. Authorizations 1130, 1150, 1155, 1160 can identify a user and one or more data processing activities from which the identified user is excluded, similarly to authorizations 1005 of FIG. 10.

Authorizations 1005 of FIG. 10 and authorizations 1130, 1150, 1155, 1160 of FIG. 11 can identify classes of excluded data processing activities rather than individual activities. Classes of activities can be organized into authorizations levels. FIG. 12 shows four different authorization levels 1205, 1210, 1215, 1220 of data processing activities. Authorization level 1205 identifies that a user is excluded from defining a tailored object class or defining authorization levels for an object class. Authorization level 1210 identifies that a user is excluded from associating a tailored object class with an operation or assigning authorization levels to participants in an operation. Authorization level 1215 identifies that a user is excluded from creating or deleting an instance of a tailored object or identifying users authorized to perform activities with the instance. Authorization level 1220 identifies that a user is excluded from modifying or enhancing an instance of a tailored object.

Authorization level 1205 can be the broadest authorization level in that it excludes the largest number of users from the identified activities, whereas authorization level 1220 can be the narrowest level in that it excludes the fewest number of users from the identified activities. For example, authorization level 1205 can exclude all users other than a manager of an object operations system from the identified activities, authorization level 1210 can exclude all users except the manager of an object operations system and a manager of an operation, authorization level 1215 can exclude all users except the manager of an object operations system, the manager of an operation, and an object administrator party to the operation, and authorization level 1220 can exclude all users except the manager of an object operations system, the manager of a operation, the object administrator(s) party to the operation, and any other party to the operation. For example, the manager of an object operations system can be a cFolders administrator, the manager of a operation can be a cFolders collaboration administrator, the object administrator(s) party to the operation can be a cFolders object administrator, and any other party to the operation can be a cFolders user in the mySAP PLM cProject Suite™ from SAP AG, Walldorf, Germany.

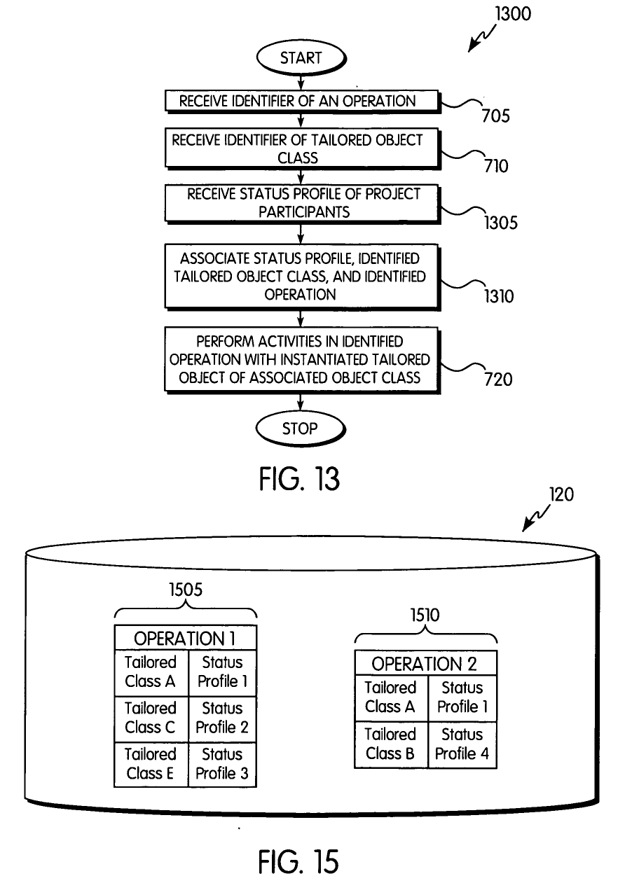

FIG. 13 shows a process 1300 in which a data processing system can use authorizations to ensure that appropriate users are excluded from performing different data processing activities involving tailored objects and tailored object classes. Process 1300 can be performed by one or more data processing devices.

The system performing process 1300 receives identifiers of an operation (step 705) and a tailored object class (step 710). The system also receives a status profile of participants in the operation (step 1305). A status profile is an association of an identification of a participant with an data processing activity in the operation from which the user is excluded. Participants can be identified by name, by characteristic, or by roll in an enterprise or in a project. The precluded data processing activity can be identified through the identification of an authorization level that includes the precluded activity. For example, a status profile can be a table of participants and the authorization level assigned to each user, or a status profile can be a table of rolls in a project and the authorization level assigned to each roll.

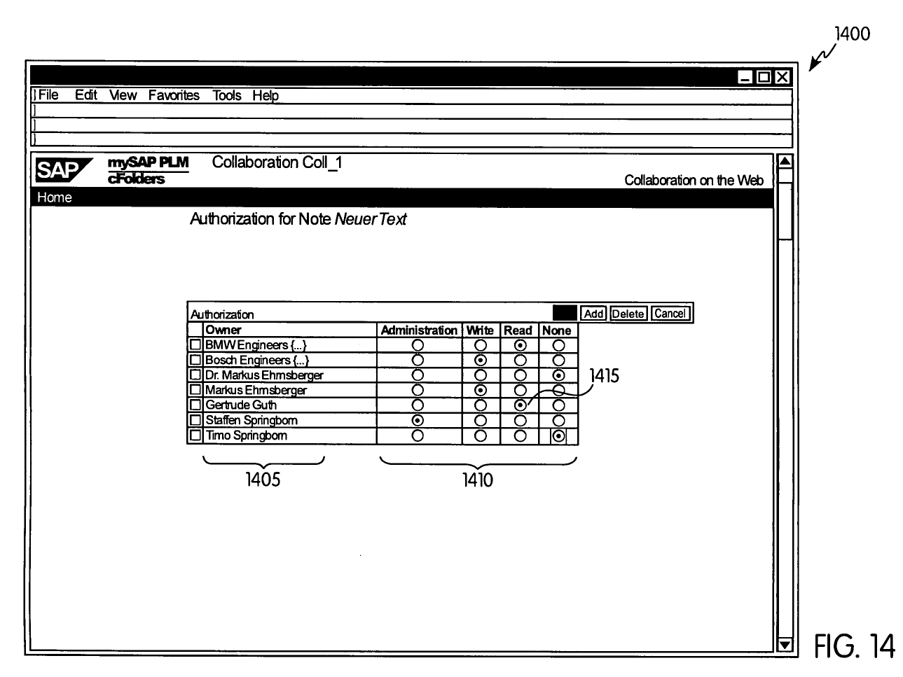

The status profile can be received from a user. For example, the system can receive the name of a participant and a precluded data processing activity from a user. FIG. 14 shows an example screenshot 1400 of a list 1405 of participant identifiers and a collection 1410 of activities in the operation. The selection of an activity in collection 1410 by a user can indicate that an identified participant is precluded from a set of higher-level activities. For example, a selection 1415 of a read activity for participant Gertrude Guth can indicate that participant Guth is precluded from administration and write activities.

A status profile can also identify changes in the precluded activities that are to occur over time. The changes in the precluded activities can be defined at the tailored object level, at the fieldgroup level, or at the field level. The changes in the precluded activities can be identified as a transition in the authorization level of the identified participant. The changes in the precluded activities can be triggered by the occurrence of an event in the operation. For example, a participant may initially be authorized to define and redefine a tailored object class. However, when the tailored object class is released during the operation, the same participant may be precluded from further defining or redefining the same tailored object class. As another example, a participant such as an external customer may initially be precluded from viewing the contents of an instance of a tailored object relating to a proposed development for the customer. However, once the proposed development has been sufficiently refined, the external customer may no longer be precluded from viewing the same tailored object instance.

The system associates the received status profile, the identified tailored object class, and the identified operation (step 1310). Associating the received status profile, the identified tailored object class, and the identified operation involves generating a machine-readable indication that the status profile is applicable for activities performed in the identified operation with the tailored object class. For example, the status profile can be associated with the tailored object class and the operation by storing the status profile in a description of the operation so that when a description of the tailored object class is accessed during the operation, the status profile is automatically invoked to exclude participants from operational activities. FIG. 15 shows an example of how a set of object operations instructions 120 can include tables 1505, 151 0 that associate status profiles with identifications of tailored object classes and various operations.

As shown in FIG. 13, the system can perform activities in the identified operation with an instantiated tailored object of the associated object class (step 720). Participants can be excluded from performing activities identified in the status profile, as appropriate.

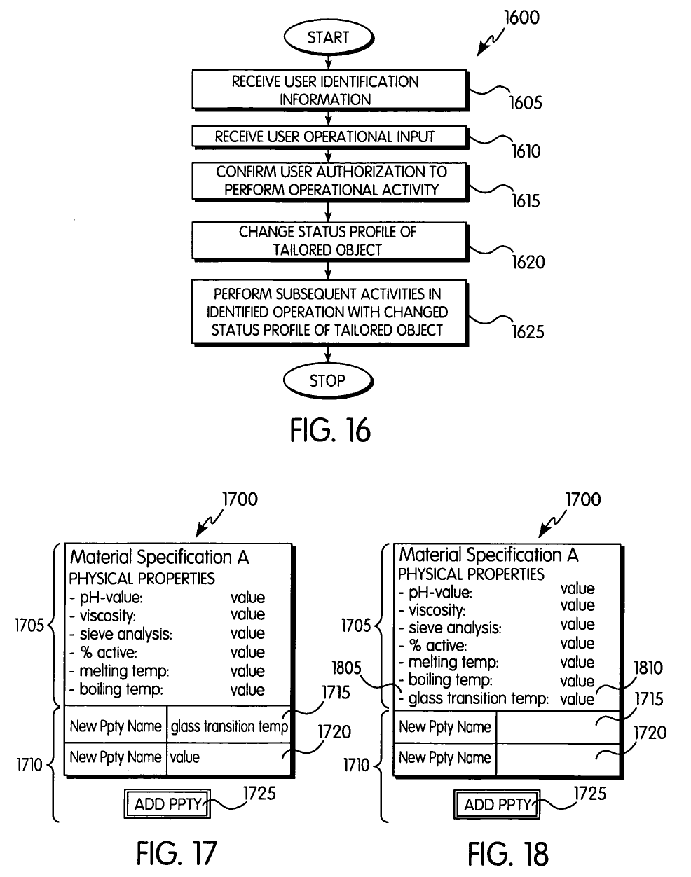

FIG. 16 shows a process 1600 in which a data processing system can use changes in status profiles to perform data processing activities involving tailored objects and tailored object classes. Process 1600 can be performed by one or more data processing devices.

A system performing process 1600 can receive user identification information (step 1605). The received information can be a user password or other information that identifies the user as a participant in a particular operation. The system also receives user operational input relating to the user's participation in an operation (step 1610). The operational input can request the performance of activities in the operation. For example, the operational input can include requests to instantiate tailored objects or read and write requests that populate or otherwise modify the content of an instantiated tailored object.

The system can confirm that the identified user is not excluded from performing an operational activity associated with the received operational input (step 1615). For example, the system can identify the operation of the activity associated with the received operational input and confirm that the identified user is not precluded from performing the operational activity in the operation by checking authorizations of objects, fieldgroups, and/or fields involved in the operational activity for the identified operation.

If the system confirms that the user is authorized to perform the operational activity, then the system can perform the requested activity. The performance of a requested activity can include changing the status profile associated with a tailored object (step 1620). The status profile can be changed automatically without user input. For example, the status profile can be changed in accordance with a rule describing how the status profile is to be changed when an event occurs. The status profile can be changed at the object, the fieldgroup, or the field level. Once the status profile is changed, the system can perform subsequent activities in the identified operation with the changed status profile of the tailored object (step 1625).

FIGS. 17 and 18 illustrate one example of how a change in the status profile associated with a tailored object can impact activities performed with the tailored object. In particular, FIG. 17 shows a display screen 1700 where a selected portion of a tailored material specification object is displayed as part of an operation involving the material. Display screen 1700 includes a physical property display portion 1705 and a user interaction portion 1710. Physical property display portion 1705 renders information from a tailored material specification object regarding the physical properties of the material for a user in the form of a table of names of properties and their values.

User interaction portion 1710 includes a new property name input area 1715, a new property value input area 1720, and an add property button 1725. New property name input area 1715 can receive a user input identifying a field in the tailored material specification object from which the user for whom property display portion 1705 is rendered is currently excluded from viewing. For example, the field in the tailored material specification object can currently be empty and hence all users are excluded from viewing the field. New property value input area 1720 can receive a value that can be used to populate the field in the tailored material specification. Add property button 1725 can receive user input triggering a change in the status profile associated with the tailored material specification object. In particular, add property button 1725 can receive a mouse click that disassociates of an identification of the user for whom property display portion 1705 is rendered with a display of the field in the tailored material specification identified in new property name input area 1715, thereby ending exclusion of the user from display of the identified field.

FIG. 18 shows display screen 1700 where the portion of the tailored material specification object is displayed with the changed status profile. Physical property display portion 1705 now renders a glass transition temperature property 1805 and value 1810 for the user.

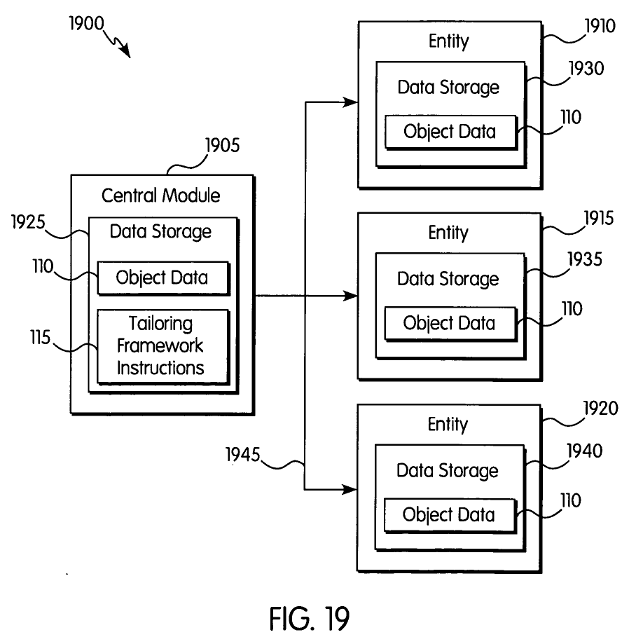

FIG. 19 shows another data processing system 1900 where tailored objects can be applied. Data processing system 1900 can be a product creation system in that it performs object operations directed toward the creation of a product.

Data processing system 1900 includes a central module 1905 and entity modules 1910, 1915, 1920. Central module 1905 includes a data storage facility 1925, entity module 1910 includes a data storage facility 1930, entity module 1915 includes a data storage facility 1935, and entity module 1920 includes a data storage facility 1940. Data storage facility 1925 stores machine-readable information and instructions such as object data 110 and tailoring framework instructions 115. Entity data storage facilities 1930, 1935, 1940 can also store machine-readable information and instructions such as object data 110. Central module 1905 and the entity modules 1910, 1915, 1920 can communicate through a data link 1945.

Entity modules 1910, 1915, 1920 can be used by different participants to participate in the product creation process. The participants can be both internal and external computer applications, companies, departments, and/or individuals. The participants can have different roles in the product creation process. For example, participants can have design roles, testing roles, purchasing roles, marketing roles, sales roles, manufacturing roles, installation roles, customer service roles, technical service roles, customer roles, dealer roles, distributor roles, supplier roles, vendor roles, or regulatory organization roles. Each entity data storage facilities 1930, 1935, 1940 can also store customized machine-readable operational instructions for performing such roll-based activities using tailored objects (not shown).

Central module 1905 can be a control center for a product creation process. For example, data storage facility 1925 can store master data for a product creation process. The master data can include both standard and tailored objects associated with the product creation process. These objects can include product classes, attributes, product line designs, parts lists, materials lists, bills of materials, quality specifications, data sheets, folders and subfolders, documents, bookmarks, discussions, text notes, requirements, routing and process structures, and other information.

Participants at each of entity modules 1910, 1915, 1920 can tailor objects as described above. The objects can be tailored to the specific roll of the participant in the product creation process. Such tailored objects can be stored at a respective of entity data storage facilities 1930, 1935, 1940. Tailored objects defined by one participant at one entity module 1910, 1915, 1920 need not be made available to other participants at other entity modules 1910, 1915, 1920. Entity modules 1910, 1915, 1920 can exchange information with central module 1905 over data link 1945 to create an object tailoring framework based on tailoring framework instructions 115. Information can be exchanged using software applications such as a web browser. Entity modules 1910, 1915, 1920 can use such an object tailoring framework to tailor objects for the product creation process in parallel. Each of entity modules 1910, 1915, 1920 can define different versions of a similar object for the product creation process. For example, entity module 191 0 can define a first material specification tailored object, whereas entity module 1915 can define a second material specification tailored object.

By allowing participants with unique rolls to tailor the storage of information to suit the participants' particular needs, the product creation process can be adapted to different products and participants by increasing flexibility in the product creation process.

Tables 1, 2, 3 include example XML files that define object classes. Please note that the XML files in Tables 1, 2, 3 include extraneous line breaks. The tailored object class definition shown in Table 1 includes document element types in the tailored elements. The tailored object class definition shown in Table 2 is intended for use with a computer aided design (CAD) application and includes a tailored field that is a link to a document structure. The tailored object class definition shown in Table 3 includes field authorizations that can be used to exclude users from data processing activities involving associated fields. The field authorizations can be assigned for each object in the object class definition shown in Table 3.

Instantiated instances of the object classes defined in tables 1, 2, and 3 can be stored at a central system or one or more entity modules. Operations using instantiated instances of the defined object classes can be performed at a central system or one or more entity modules. Information regarding the object classes, including definitions and instances of the object classes themselves, can be exchanged between data processing systems using communications applications such as a web service and a web browser.

Object classes can be defined in formats other than XML files. For example, other markup language files can be used to define object classes. Also, object classes need not be stored in a hierarchical format, as descibed herein. For example, if a data storage device does not store hierarchical, structured data, the heirarchical data can be temporarily converted into a linear form for storage and then reconverted to hierarchical format upon retrieval.

The invention can be implemented in digital electronic circuitry, or in computer hardware, firmware, software, or in combinations of them. The invention can be implemented as a computer program product, i.e., a computer program tangibly embodied in an information carrier, for example, in a machine-readable storage device or in a propagated signal, for execution by, or to control the operation of, data processing apparatus, for example, a

```
TABLE 1
<?xml version=“1.0” encoding=“iso-8859-1” ?>
- <GenericObjectType ID=“DocumentStructure” Namespace=“SAP”
    IsStandardObjectType=“true”
    xmlns=“http://www.sap.com/2002/abap/cfx_folders/customizing/
    Generic
    ObjectType”>
    <Name Alias=“” Default=“Document Structure” />
    <Description Alias=“” Default=“A document structure structures
      documents and represents a directory of all parts (items) that
      belong to a document.” />
    <Icon Href=“s_b_slis.gif” />
  - <DataTypes>
      <DataType ID=“String” Namespace=“SAP” Type=“string” />
      <DataType ID=“Integer10” Namespace=“SAP” Type=“integer”
        Length=“10” />
    - <DataType ID=“Unit” Namespace=“SAP” Type=“enumeration”>
      - <AllowedValues>
          <AllowedValue Alias=“” Default=“Pieces” Value=“piece” />
          <AllowedValue Alias=“” Default=“Meter” Value=“m” />
          <AllowedValue Alias=“” Default=“Centimeter” Value=
          “cm” />
        </AllowedValues>
      </DataType>
    - <DataType ID=“Document” Namespace=“SAP” Type=“IDREF”>
      - <AllowedObjectTypeRefs>
          <AllowedObjectTypeRef ID=“doc” />
        </AllowedObjectTypeRefs>
      </DataType>
    </DataTypes>
  - <NonStructuredElements>
    <PropertyLists>
      - <PropertyList>
          <Heading Alias=“” Default=“” />
        - <Properties>
          - <Property>
            - <Fields>
              - <Field ID=“CAD_Format” Namespace=“SAP”
                  DisplayLines=“1” IsConstant=“false”
                  IsEntryRequired=“false”
                  HasMultipleValues=“false”>
                  <Label Alias=“” Default=“CAD Format” />
                  <DataTypeRef ID=“String”
                    Namespace=“SAP” />
                </Field>
              </Fields>
            </Property>
          </Properties>
        </PropertyList>
      </PropertyLists>
    </NonStructuredElements>
  - <StructuredElements>
    - <ItemList IsNewItemAllowed=“true”>
        <Heading Alias=“” Default=“Documents” />
      - <AllItems>
        - <PropertyLists>
          - <PropertyList>
              <Heading Alias=“” Default=“” />
            - <Properties>
              - <Property>
                - <Fields>
                  - <Field ID=“Item” Namespace=“SAP”
                      DisplayLines=“1” IsConstant=“false”
                      IsEntryRequired=“true”
                      HasMultipleValues=“false”>
                      <Label Alias=“” Default=“Item” />
                      <DataTypeRef ID=“Integer10”
                        Namespace=“SAP” />
                    </Field>
                  </Fields>
                </Property>
              - <Property>
                - <Fields>
                  - <Field ID=“Description”
                      Namespace=“SAP” DisplayLines=“5”
                      IsConstant=“false”
                      IsEntryRequired=“false”
                      HasMultipleValues=“false”>
                      <Label Alias=“”
                        Default=“Description” />
                      <DataTypeRef ID=“String”
                        Namespace=“SAP” />
                    </Field>
                  </Fields>
                </Property>
              - <Property>
                - <Fields>
                  - <Field ID=“Document_REF”
                      Namespace=“SAP” DisplayLines=“1”
                      IsConstant=“false”
                      IsEntryRequired=“false”
                      HasMultipleValues=“false”>
                      <Label Alias=“”
                        Default=“Dokument” />
                      <DataTypeRef ID=“Document”
                        Namespace=“SAP” />
                    </Field>
                  </Fields>
                </Property>
              - <Property>
                - <Fields>
                  - <Field ID=“Quantity”
                      Namespace=“SAP” DisplayLines=“1”
                      IsConstant=“false”
                      IsEntryRequired=“false”
                      HasMultipleValues=“false”>
                      <Label Alias=“”
                        Default=“Quantity” />
                      <DataTypeRef ID=“Integer10”
                        Namespace=“SAP” />
                    </Field>
                  - <Field ID=“QuantityUnit”
                      Namespace=“SAP” DisplayLines=“1”
                      IsConstant=“false”
                      IsEntryRequired=“false”
                      HasMultipleValues=“false”>
                      <Label Alias=“” Default=“Quantity
                        Unit” />
                      <DataTypeRef ID=“Unit”
                        Namespace=“SAP” />
                    </Field>
                  </Fields>
                </Property>
              </Properties>
            </PropertyList>
          </PropertyLists>
        </AllItems>
      - <FieldInOverviewRefs>
          <FieldInOverviewRef ID=“Item” Namespace=“SAP” />
          <FieldInOverviewRef ID=“Document_REF”
          Namespace=“SAP”
            />
        </FieldInoverviewRefs>
      </ItemList>
    </StructuredElements>
  </GenericObjectType>
```

```
TABLE 2
<?xml version=“1.0” encoding=“iso-8859-1” ?>
- <GenericObjectType ID=“CAD_Document” Namespace=“SAP”
    IsStandardObjectType=“true”
    xmlns=“http://www.sap.com/2002/abap/cfx_folders/customizing/
    GenericObjectType”>
  - <CategoryForRefs>
      <CategoryForRef ID=“doc” />
    </CategoryForRefs>
    <Name Alias=“” Default=“CAD Document” />
    <Description Alias=“” Default=“A CAD document can be used in
      document structures.” />
  - <DataTypes>
    - <DataType ID=“DocumentStructure” Namespace=“SAP”
        Type=“IDREF”>
      - <AllowedObjectTypeRefs>
          <AllowedObjectTypeRef ID=“DocumentStructure”
            Namespace=“SAP” />
        </AllowedObjectTypeRefs>
      </DataType>
    </DataTypes>
  - <NonStructuredElements>
    - <PropertyLists>
      - <PropertyList>
          <Heading Alias=“” Default=“” />
        - <Properties>
          - <Property>
            - <Fields>
              - <Field ID=“DocumetStructureRef”
                  Namespace=“SAP” IsConstant=“false”
                  IsEntryRequired=“false”
                  HasMultipleValues=“false”>
                  <Label Alias=“” Default=“Document
                    Structure” />
                  <DataTypeRef ID=“DocumentStructure”
                    Namespace=“SAP” />
                </Field>
              </Fields>
            </Property>
          </Properties>
        </PropertyList>
      </PropertyLists>
    </NonStructuredElements>
  </GenericObjectType>
```

programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. Information carriers suitable for embodying computer program instructions and data include all forms of non-volatile memory, including by way of example semiconductor memory devices, for example, EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input.

The invention can be implemented in a computing system that includes a back-end component, for example, as a data server, or that includes a middleware component, for example, an application server, or that includes a front-end component, for example, a client computer having a graphical user interface or an Web browser through which a user can interact with an implementation of the invention, or any combination of such back-end, middleware, or front-end components. The components of the system can be interconnected by any form or medium of digital data communication, for example, a communication network. Examples of communication networks include a local area network (“LAN”), a wide area network (“WAN”), and the Internet.

A number of implementations of the invention have been described. Nevertheless, it will be understood that various modifications may be made without departing from the spirit and scope of the invention. For example, an object class can be declared with modifiers that indicate whether the class is public, abstract, or final, a class name, a superclass name, and a list of the interfaces implemented by the class. Process steps can be performed in different order. Accordingly, other implementations are within the scope of the following claims.

1. A computer program product, tangibly embodied in an information carrier, for tailoring the storage of information, the computer program product being operable to cause data processing apparatus to create a framework of elements to:
present a user with a presentation of options for tailoring an object;
receive user input for tailoring the object in response to the presentation of options, the user input identifying
a first field to be included in the tailored object,
a second field to be included in the tailored object,
a first participant, and
a second participant;
define the tailored object to include the first field and the second field;
associate an identifier of the first participant with the first field to indicate that the first participant is to be excluded from a first activity performed with the first field; and
associate an identifier of the second participant with the second field to indicate that the second participant is to be excluded from a second activity performed with the second field.

2. The computer program product of claim 1, wherein the instructions also cause the processor to create a framework of elements to:
exclude the first participant from the first activity performed with the first field.

3. The computer program product of claim 1, wherein the instructions cause the processor to create a framework of elements to receive user input identifying a roll that the first participant plays in an operation.

4. The computer program product of claim 3, wherein the instructions cause the processor to create a framework of elements to associate an identifier of the roll with the first field.

5. The computer program product of claim 1, wherein the instructions cause the processor to create a framework of elements to receive user input identifying a fieldgroup that includes the field.

6. The computer program product of claim 1, wherein the instructions cause the processor to create a framework of elements to:
receive first user input identifying the first field and the second field from a first user; and
receive second user input identifying the first participant and the second participant from a second user.

7. The computer program product of claim 1, wherein the instructions also cause the processor to create a framework of elements to:
receive user input identifying the first activity from which the first user is excluded from performing with the first field.

8. The computer program product of claim 7, wherein the instructions cause the processor to create a framework of elements to receive user input identifying an authorization level identifying the first activity from which the user is precluded.

9. The computer program product of claim 8, wherein the instructions cause the processor to create a framework of elements to receive user input selecting the authorization level from a group of at least four authorization levels.

10. The computer program product of claim 1, wherein the instructions also cause the processor to create a framework of elements to:
identify a trigger; and
based upon the identification of the trigger, end the association of the identifier of the first participant with the first field to indicate that the first participant is no longer excluded from the first activity.

11. The computer program product of claim 1, wherein the instructions also cause the processor to create a framework of elements to:
receive user input identifying a noperation performed with the tailored object; and
associate an identifier of the operation, the identifier of the first participant, and the first field to indicate that the first participant is to be excluded from the first activity performed with the first field in the operation.

12. The computer program product of claim 11, wherein the instructions cause the processor to create a framework of elements to receive user input identifying a collaboration of at least two parties.

13. The computer program product of claim 1, wherein the instructions also cause the processor to create a framework of elements to:
instantiate the defined tailored object.

14. The computer program product of claim 1, wherein:
the first activity comprises display of the first field; and
the second activity comprises display of the second field.

15. The computer program product of claim 1, wherein the instructions cause the processor to create a graphical user interface to lead an untrained user through the tailoring.

16. The computer program product of claim 15, wherein the instructions cause the processor to create the graphical user interface on an web browser.

17. A system comprising:
a data storage device including tailored data objects, the tailored data objects having user-defined data fields; and
a data processing device in data communication with the information storage device, the data processing device configured to perform data processing activities in accordance with a set of machine-readable instructions, the activities including
identifying a trigger;
changing a status of a field in a first tailored object based on the identification of the trigger, the status of the field identifying an activity performed with the field and a participant who is excluded from performing the activity with the field.

18. The system of claim 17, wherein changing the status of the field includes:
ending a preclusion of the identified participant from performance of the identified activity.

19. The system of claim 18, wherein changing the status of the field includes:
releasing a predefined field for display for all participants.

20. The system of claim 17, further comprising:
operational instructions for the creation of a product.

21. The system of claim 17, wherein the first tailored data object comprises:
structured elements hardcoded into the first tailored data object and hence not definable by a user; and
tailored elements including the user-defined data fields.

22. The system of claim 21, wherein the standard elements comprise elements found in every member of a group of data objects that includes the first tailored data object.

23. The system of claim 17, wherein the data processing device activities further include:
receiving user input identifying an operation performed with the tailored object, the operation including the activity performed with the field; and
associating an identifier of the operation with the status to indicate that the status is relevant to the operation.

24. The system of claim 23, wherein the data processing device activity of receiving user input identifying the operation includes:
receiving user input identifying a collaboration of at least two parties.

25. A memory for storing data for access during performance of a set of machine-readable instructions for performing operations on a data processing system, comprising:
a data structure stored in the memory, the data structure including
a data structure identifier;
a collection of one or more hardcoded elements hardcoded into the data structure;
a collection of one or more tailored elements to fit a specific data processing activity of a user.

26. The memory of claim 25, wherein the data structure further comprises:
user identification information identifying a user; and
activity identification information identifying an activity from which the user is excluded.

27. The memory of claim 26, wherein:
the collection of tailored elements comprises a field to fit the specific data processing activity; and
the activity identification information identifies the activity according to the field in the collection of tailored elements.

28. The memory of claim 26, wherein the user identification information comprises an authorization level.

29. The memory of claim 28, wherein the user identification information comprises one of four or more authorization levels.

30. The memory of claim 25, further comprising an association identifying that the data structure is associated with a particular operation.

31. The memory of claim 25, wherein the data structure comprises an XML file.

32. The memory of claim 25, further comprising a communications application for exchange of the data structure with a remote system.

33. The memory of claim 32, wherein the communications application comprises a web service.
